(19) United States
(12) Patent Application Publication
(10) Pub. No.: US 2019/0339914 A1
(43) Pub. Date: Nov. 7, 2019

(54) METHOD FOR PRODUCING A COLOR ACCURATE PROOF OF A PRINTED PRODUCT

(71) Applicant: ESKO Software BVBA, Gent (BE)

(72) Inventor: Lieven Plettinck, Wingene (BE)

(73) Assignee: ESKO Software BVBA, Gent (BE)

(21) Appl. No.: 16/481,110

(22) PCT Filed: Jan. 25, 2018
(86) PCT No.: PCT/EP2018/051881

§ 371 Date: Jul. 26, 2019

Related U.S. Application Data
(60) Provisional application No. 62/450,621, filed on Jan. 26, 2017.

(51) Int. Cl. G06F 3/12; H04N 1/60; H04N 1/23; H04N 1/32

(52) U.S. Cl. CPC G06F 3/1208; H04N 1/6008; H04N 1/6022; H04N 1/32523; G06F 3/1298; G06F 3/1257; G06F 3/1231; H04N 1/2315

(57) ABSTRACT

In this method, a surface of a digital master of the printed product is subdivided into a plurality of areas based on at least a first area of the printed product being printed having a first set of color-affecting printing characteristics and at least a second area of the printed product having a second set of color-affecting printing characteristics. Each of the plurality of areas are assigned a printing press color profile or device link, and the colors from colorspaces corresponding to each set of color-affective printing characteristics are converted to a colorspace of the proofing device. This conversion is accomplished by determining, for each pixel, one of the plurality of areas of the digital master surface that the pixel belongs to, selecting the color profile or the device link profile, converting the values to proof colorant values, and assigning the proof colorant values to the proof.

This application is related to, and claims the benefit of priority of, U.S. Provisional Application No. 62/450,621 filed on 26 Jan. 2017, the contents of which are incorporated herein by reference in their entirety for all purposes.

### FIELD

This invention relates generally to a method of producing a color accurate proof of a printed product, where the printed product is produced using multiple printing processes.

### BACKGROUND

In packaging design and production workflow, it is common to have one or more approval steps before the actual production process (including printing) is started. During these approval steps, digital master files (e.g. PDF files) are checked against the initial requirements of the print-buyer (e.g. a brand-owner) for quality and accuracy. This “proofing process” is performed to minimize errors that present for the first time upon printing. During these approval steps, several aspects of the package are typically checked, e.g., content (e.g. text), technical aspects (e.g. cutting shape) and color.

Color is often an important brand-asset of a brand-owner. It is often critical that colors on a package are reproduced accurately and consistently on packaging, literature, and the like that is provided to the consumer. A brand color not reproduced accurately on a package may lower the recognition and confidence in the brand. For this reason, many brand owners may require the use of spot colors (e.g. a specific ink characterized by a specific spot color having a specific Pantone® value or specific trade name) in printing packaging for its products, because the combination of CMYK by itself may be incapable of reliably reproducing the brand-critical color.

To verify colors, approvers rely on color-matched proofs, such as hard-copy proofs rendered using a digital proofing system (e.g. an inkjet printing device) and/or “soft” proofs rendered using a color-calibrated screen. Through well-known color management techniques, a print is made using, for example, an inkjet printing device and presented to the approver under well-specified viewing conditions (e.g. D50 illumination) or an image is placed on a computer screen in such a way as to provide a visual match between the proof and the appearance of the final printed result under specified viewing conditions (e.g. D50 illumination).

State-of-the-art technology, however, assumes a single printing process is used to print the final product. Consequently, this assumption introduces an inherent limitation of only a single printing device profile or device link being used for an entire surface of the digital master. This limitation makes it impossible to generate a fully accurate proof of printed products intended for printing using a multi-stage process involving multiple printing devices.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A shows a schematic representation of an exemplary printing device (e.g. offset press) connected to a computer.

FIG. 1B shows a schematic representation of an exemplary printing device (e.g. digital inkjet printing device) connected to a computer.

FIG. 2A shows a block diagram of a first color management technique for producing a proof.

FIG. 2B shows a block diagram of a second color management technique for producing a proof.

FIG. 3 shows a block diagram of a proofing system that includes a proofing device that displays soft proofs and a proofing device that prints hard proofs.

FIG. 4 shows a product identifier printed by a Combi printing process.

FIG. 5 shows a product identifier printed by a Varnish Layer printing process.

FIG. 6 shows a product identifier printed by a White Underprint printing process.

FIG. 7 shows a flowchart of the overall proofing process.

FIG. 8 shows details of step 704 in FIG. 7.

### SUMMARY

One embodiment relates to a method to produce a color accurate proof of a printed product. The method includes a step of subdividing, by a host computer, a surface of a digital master of the printed product into a plurality of areas based on at least a first area of the printed product being printed having a first set of color-affecting printing characteristics and at least a second area of the printed product having a second set of color-affecting printing characteristics. The method includes another step of assigning, by the host computer, each of the plurality of areas a printing press color profile or device link based on the respective set of color-affecting printing characteristics corresponding to the respective area. The method includes yet another step of converting, by the host computer, colors from color spaces corresponding to each set of color-affective printing characteristics to a color space of a proofing device (e.g. a computer display or hard-copy proofing device). This conversion is accomplished by determining, by the host computer, for each pixel at location (x, y) at least one of the plurality of areas of the digital master surface that the pixel belongs to, where x and y are variables defining a two dimensional space of the digital master, selecting, by the host computer, the color profile or the device link profile assigned to each of the determined areas, resulting in a list of color profiles or device links, converting, by the host computer, final print color-affecting values to proof colorant values using the list of printing press profiles or device links, and assigning, by the host computer, the proof colorant values to the pixel (x′, y′) of the proof that corresponds with location (x, y) of the digital master surface.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Printed products (e.g. packaging labels, boxes, etc.) may benefit from a multi-step printing process, during which a first portion of the printed product is printed using a first printing device, and a second portion of the printed product is printed using a second printing device. For example, the first printing device may be a printing press (e.g. offset press, flexography press, gravure press, etc.), while the second printing device may be a digital printing device (e.g. inkjet printing device).

In one example, portions of the printed product (e.g. portions of the packaging label) may include background images and information that are common to various versions of a consumer product (e.g. a wrist watch). These common portions of the packaging label may be quickly and efficiently produced in high quantities by, for example, the offset press to produce “generic” labels. The printed product, however, may also include images and information that are specific to various versions of the consumer product (e.g. different color watches). The portions of the printed product that show the consumer product may be printed by a different digital printing process after the initial printing of the generic content, such as on-demand, as needed. For example, the generic images/information of the printed product may be printed by the offset press in a first step, while the specific images/information of the printed product may be printed by a digital printing device in a second step. Although one exemplary use of the present invention is in connection with “product identifiers,” as this term is used herein to refer to any portion of a printed product that may convey specific identifying information about goods related to the printed product (e.g. an image of goods contained in a printed box; a barcode corresponding to the goods contained in a printed box; a size (S, M, L, XL, 2, 4, 6, 8, 32, 34, 36, etc.)), the present invention is not limited to any particular type of product identifier, the invention is also not limited to the printing of product identifiers. Any reason for printing one portion of a printed product with one printing profile and another with a different printing profile may benefit from aspects of the invention as described herein.

A proof is typically generated for review, to ensure the accuracy of the printed product prior to making a full printing run. A soft proof typically comprises an image displayed on a proofing device (e.g. computer screen) from a computer file, such as a portable document format (PDF) file, and reviewed by a person (e.g. approver) responsible for approving the images on the computer screen connected to a host computer. The soft proof image may be generated by the host computer of the proofing device, or by another computer (e.g. a remote computer that creates the soft proof and sends it to the host computer of the proofing device). The proof essentially shows the approver how the printed product will look when printed by a specific printing device (e.g. specific printing device) having a specific color gamut (e.g. range of printable colors). Conventional proofs for printed products assume the job will be printed entirely by a single printing device, and therefore only utilize a single color profile associated with that printing device when creating the soft proof. Likewise, a hard proof may be printed using a proofing device (e.g. printing device) configured with settings to mimic the final printing device, but again, the state of the art provides only for mimicking the settings of one final printing device at a time.

The present invention, however, is ideally suited for proofing a multi-step printing process that utilizes multiple printing devices in which each printing device utilizes a unique color profile that describes a color gamut for each respective printing device. To accurately proof a printed product produced by such a method, a soft proof document (e.g. a Consolidated File such as a PDF file), referred to herein as a “digital master,” having multiple color profiles (e.g. a color profile for each printing device) is provided.

As described above, multiple printing devices may be used during a multi-step printing process to produce a printed product. Printing device examples include, but are not limited to an offset press and an digital inkjet printing device. The examples described throughout the specification assume that these two types of printing devices are utilized. However, it should be noted that the proofing method described throughout, may be used for proofing any number of two or more printing devices and any types of printing devices each having color profiles and/or device links.

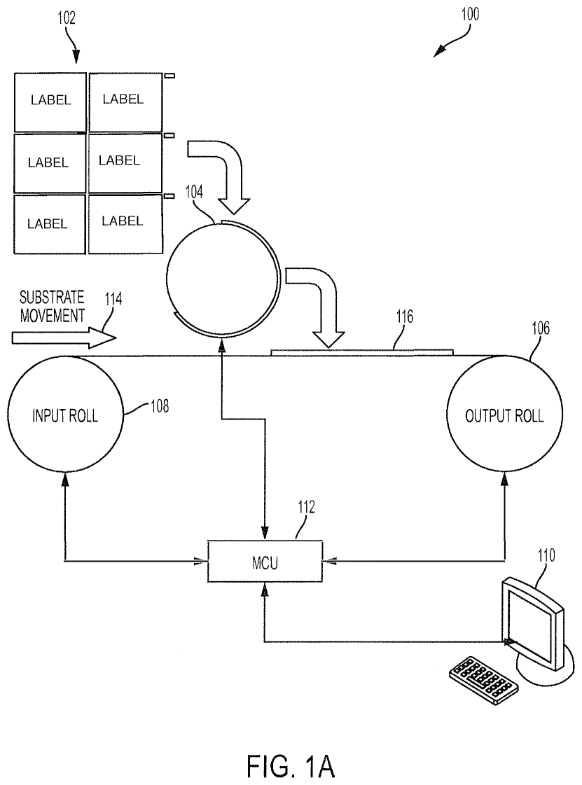

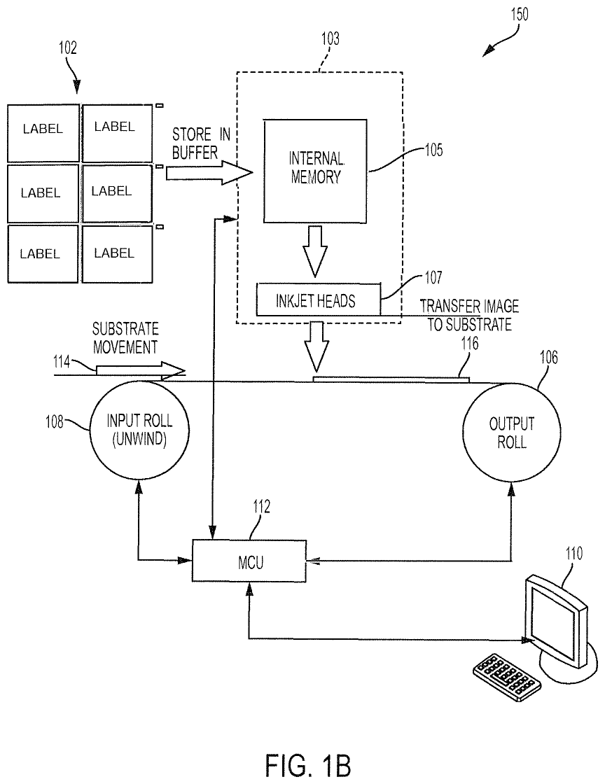

Shown in FIG. 1A is a system diagram for an exemplary offset press printing device for printing an exemplary product identifier 102 (e.g. product label). The offset press includes an intermediate drum 104, an input roll 108 of the substrate, an output roll 106 of the substrate, a microcontroller unit MCU 112 and a computer 110 for controlling the overall printing operation. During operation, the substrate moves in direction 114 as the substrate unwinds from input roll 108 and is rewound on output roll 106. Intermediate drum 104 applies the ink to the substrate as shown as element 116.

Operation of offset press 100 shown in FIG. 1A is typically controlled by a computer 110, which may receive inputs from a human operator employed by the print shop. The operator may send commands to microcontroller unit 112, which then controls the direction and speed of intermediate roller 104, input roller 108, output roller 106, as well as ink of the intermediate drum, among others.

Shown in FIG. 1B is an exemplary digital printing system 150 comprising an ink jet printing device 103 having both internal memory 105 and ink jet heads 107 for applying ink to a substrate. Similar to the intermediate drum example shown in FIG. 1A, the ink jet printing system also includes an input roll 108 and an output roll 106, which together move the substrate in direction 114 underneath ink jet heads 107, which ultimately apply ink to the substrate to create the transferred image 116. Also similar to FIG. 1A, the ink jet printing system may include a microcontroller unit 112 and a computer 110 for controlling the overall printing system.

In the digital printing system 150 shown in FIG. 1B, the computer 110 stores product identifier 102 in internal memory 104 of the ink jet printing device 103. The computer 110 then instructs the microcontroller unit 112 to control the speed and direction of input roll 108 and output roll 106, as well as the printing operation of ink jet heads 107 based on the parameters of product identifier 102.

As described above, the intermediate drum printing system 100 in FIG. 1A and the digital printing system 150 in FIG. 1B may be used in conjunction to produce product identifier 102 in a multi-step printing process. Each of these printing devices has a different color profile and/or device link that, in accordance with the present invention, is taken into account when creating the proof that is displayed during the proofing process (prior to actual printing).

In one example, color matched proofs are created using color management techniques in which an image displayed on a computer screen is configured to mimic the color of the final printed result under specified viewing conditions (e.g. D50 illumination). Examples of such color management techniques are described in further below.

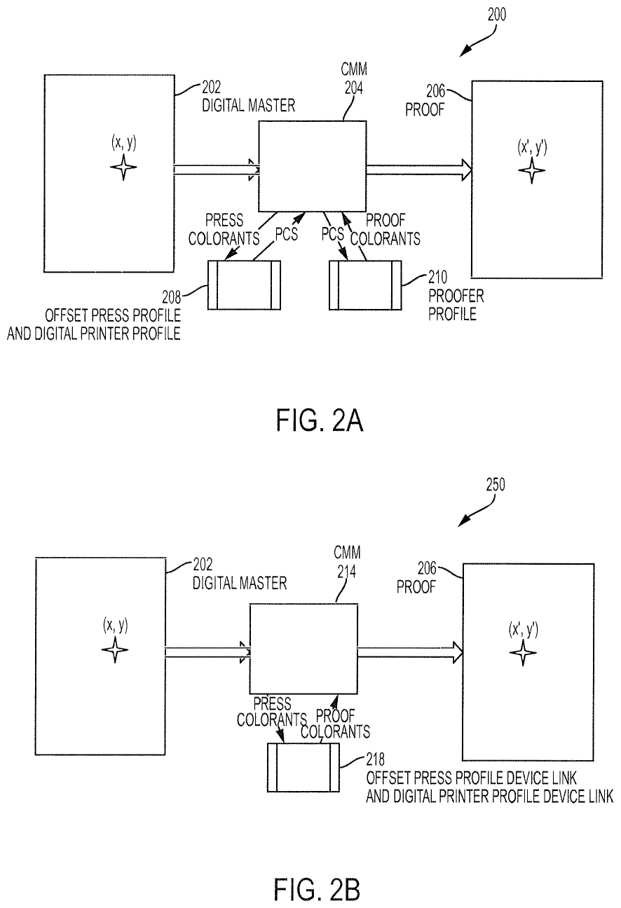

One example of a color management technique for generating a proof is shown in FIG. 2A. A digital master 202 is a digital image (e.g. a Consolidated File such as a PDF file) of the product identifier (e.g. the product label) stored and displayed using the color gamut of the proofing device connected to a host computer. In order to create a proof 206 that shows a realistic image depicting the printed product from digital master 202, printing-device-dependent values of both the printing devices to be used in the multi-printing device workflow (e.g. an offset press and a digital printing device) are determined for every pixel location (x, y) in the digital master and converted to the proof by a CMM (Color Management Module) 204.

For example, the product identifier (e.g. label) may be divided into areas (e.g. first areas to be printed by the offset press and second areas to be printed by the digital printing device). These areas may or may not overlap each other. For example, the first area and second area may be distinct from each other. Alternatively, the first area and second area may at least partially overlap each other.

Then, printing-device-dependent values of the offset press and printing-device-dependent values of the digital printing device (e.g. corresponding to the respective colorants used by each printing device) are converted by CMM 204 to a device-independent Profile Connection Space (PCS) for each respective area. Specifically, the printing-device-dependent values of the offset press colorants are converted by CMM 204 to a device-independent PCS using the offset press color profile 208. Similarly, the printing-device-dependent values of the digital printing device colorants are converted by CMM 204 to a device independent PCS using the digital printing device color profile 208.

Once the PCS is created for each printing device profile, CMM 204 then converts these PCS values to proofing device colorants using proofing device profile 210. The CMM 204 uses algorithms devised to provide a visual match between the final printed product (e.g. label) and the proof given certain viewing conditions. The proofing device essentially produces colors with device-dependent proofing device colorants at a location (x′, y′) that corresponds with location (x, y) on the final printed product.

A variant of the color management technique in FIG. 2A is shown in FIG. 2B. This implementation uses device links instead of the color profiles. A device link is essentially a data structure that describes the conversion from device-dependent values of printing device colorants directly to device-dependent values of proofing device colorants without passing through the PCS.

For example, as described above, the product identifier (e.g. label) may be divided into distinct areas (e.g. areas to be printed by the offset press and areas to be printed by the digital printing device). Then, printing-device-dependent values corresponding to the colorants of the offset press and printing-device-dependent values corresponding to the colorants of the digital printing device are converted by CMM 214 to values corresponding to proofing device colorants. Specifically, the printing device dependent values of the offset press colorants are converted by CMM 214 to proofing device colorant values using offset press profile device link 218. Similarly, the printing device dependent values of the digital printing device colorants are converted by CMM 304 to proof colorant values using digital printing device profile device link 218. Similar to the method illustrated in FIG. 2A, CMM 214 uses algorithms devised to provide a visual match between the final printed product (e.g. label) and the proof under certain viewing conditions. The proofing device essentially produces colors with device dependent proofing device colorants at a location (x′, y′) that corresponds with location (x, y) on the final printed product.

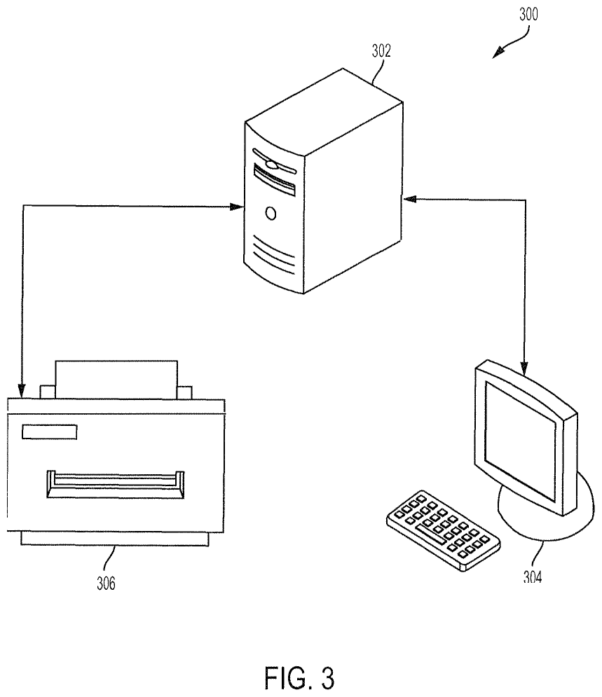

Either of the methods described in FIGS. 2A or 2B (e.g. printing device profile method, and device link method) may be used to create a proof of the final printed product either in soft form on a screen or in hard form using printing inks. An example of a proofing system 300 for generating and then displaying the soft proof and/or printing the hard proof is shown in FIG. 3. This system 300 includes a proofing device host computer 302 that generates the proofs in software, a proofing device 304 (e.g. computer screen) that displays soft proofs and a proofing device 306 (e.g. inkjet printer) that prints hard proofs. It should be noted that system 300 does not require both soft proofing device 304 and hard proofing device 306. It should also be noted that proofing device host computer 302 may be local or remote from proofing devices 304 and/or 306.

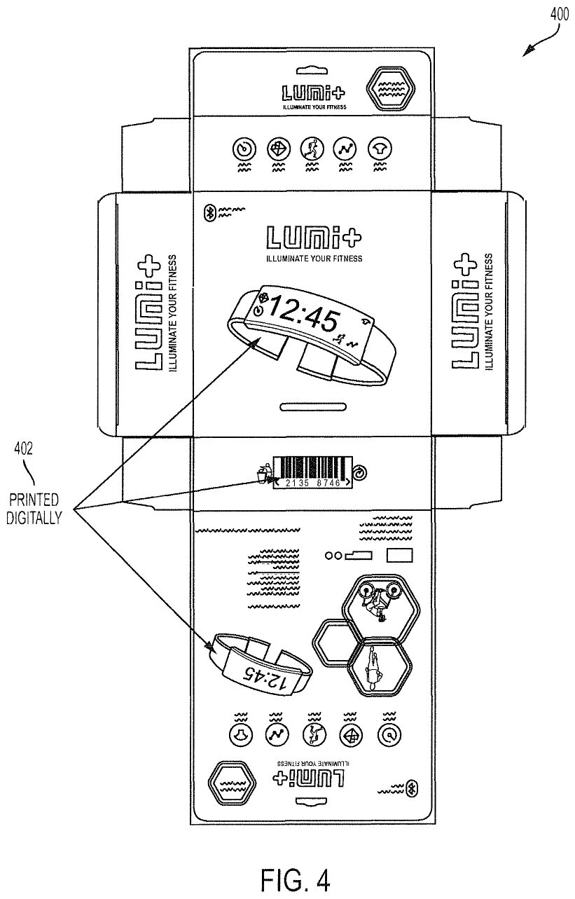

Implementing the proofing methods in FIGS. 2A or 2B for product identifiers that are printed in multi-step printing processes may be achieved in a number of methods in which different profiles are used for different portions of the printed product. Some of these methods are described in the examples provided in FIGS. 4-6 below.

For explanatory purposes, each of the methods described in FIGS. 4-6 are illustrated in connection with methods for producing proofs for a printed product (e.g. box for packaging a wrist watch) to be printed in a two stage printing process. In the first stage, an offset printing device prints a first portion of the printed product. In a second stage, a digital printing device prints a second portion of the printed product. The first and second portions may or may not overlap each other. It should be noted that the multi-step printing process may utilize other types of printing devices, and may be implemented in more than two stages.

A first example of generating a proof of a printed product to be produced using a multi-stage printing processes relates to “Combi Printing” (see FIG. 4). In this example, the printing process includes two steps for printing images and information onto the printed product (e.g. a box) that is used to package a consumer product (e.g. a wrist watch). The printed box is shown as element 400 in FIG. 4.

First, an offset press prints images onto the box with the exception of images 402 of the watch and a barcode identifying the watch packaged in the box (e.g. these areas left unprinted by the press). Using, for example, cyan-magenta-yellow-key (CMYK) offset printing, the offset printing device is able to produce a large number of “generic boxes” in a fast and cost effective manner.

Later, a print order for specific variants of the boxes (e.g. boxes for different color watches) may be received. In response to these orders, the manufacturer of the box can retrieve the generic pre-printed boxes from the warehouse, and print the variants of the colored watches on the pre-printed boxes in the appropriate areas. For example, a short digital print run may be started to convert the generic boxes into specific boxes for the different color watches by printing the watch and barcode on the preprinted boxes. This may be beneficial, because the product shots of the watch may have bright colors that are not achievable by the offset press, but are achievable within the gamut of the digital printing device. In some embodiments, the specific colors may be a spot color (e.g. a specific ink having a characterized color rather than using a combination of CMYK inks to produce that color).

In order to properly proof these boxes prior to printing, it may not be possible to describe the color characteristics of the surface of this printed box with a single color profile or device link due to the different areas being printed by different printing devices (e.g. different printing devices having different profiles or links). In one example, a first profile or device link may be needed for areas printed by the offset press, whereas a second profile or device link may be needed for areas printed by the digital printing device. Therefore, the profile proof conversion method shown in FIG. 2A and the device link conversion method shown in FIG. 2B may employ two profiles or two device links when creating the proof for the printed product. This ensures that proof 206/306 is accurately displayed to the user (e.g. approver) on the computer screen based on the unique characteristics of the different printing devices.

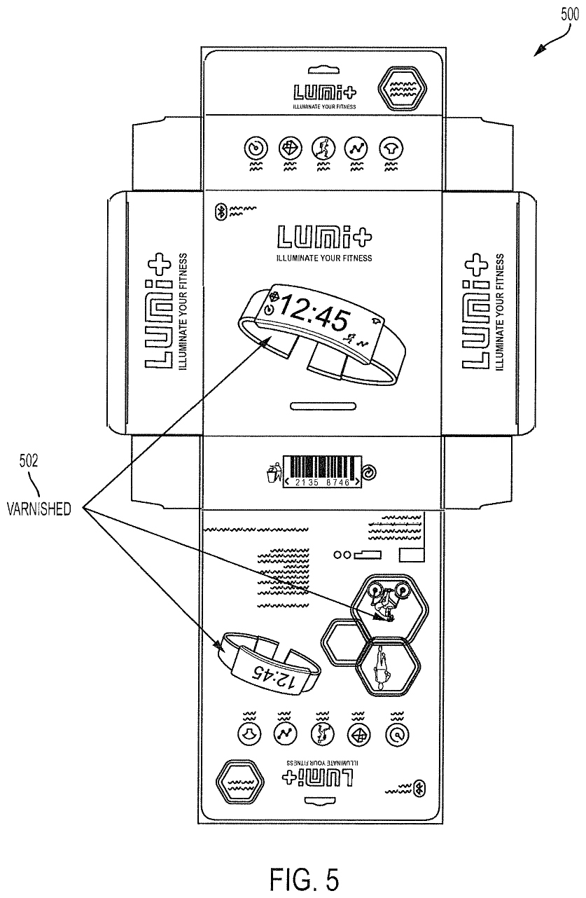

A second example of making a proof of printed products to be produced using a multi-stage printing process refers to a “Varnish Printing” process (see FIG. 5). In this example, the printing process includes two steps for printing images and information onto the box that is used to package the watch as element 500 in FIG. 5.

In this example, the whole box (including the watch and barcode) is printed using an offset press in a first step. In a finishing step, a varnish layer may be applied over the color image area of the watch. Applying varnish on top of a printed image boosts the colors of the watch. In this example, the varnish is applied using the same offset printing device in a separate step after the first printing step, but in other variations, the varnish may be provided using a different printing device.

To properly proof these boxes prior to printing, it may not possible to describe the color characteristics of the surface of this printed box with a single color profile or device link due to the multiple printing steps resulting in varnish over less than the entire area of the box. In one example, a first profile or device link may be needed for the areas unvarnished areas, while a second profile or device link may be needed for the varnished areas. Therefore, the profile proof conversion method shown in FIG. 2A and the device link conversion method shown in FIG. 2B may employ two profiles or two device links when creating the proof for the printed product e.g., one profile/link characterizing the unvarnished areas, and a second profile/link characterizing the varnished areas. This ensures that proof 206/306 is accurately displayed to the user based on the unique characteristics of the different areas of the final print.

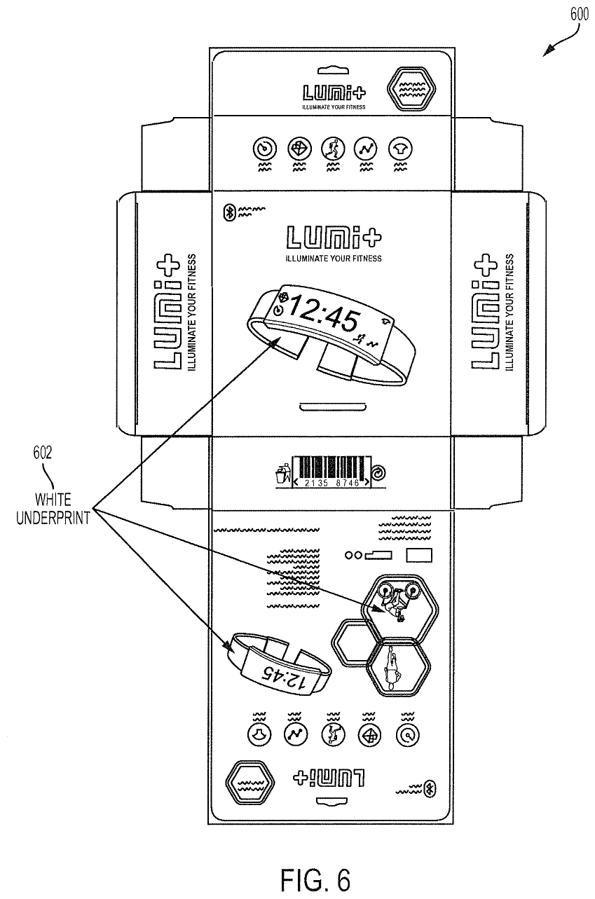

Yet a third example of making a proof of printed product to be produced using a multi-stage printing process relates to a “White Underprint” process (see FIG. 6). In this example, the printing process includes two steps for printing images and information onto the box 600 that is used to package the watch shown in FIG. 6.

First, the whole box is printed using, e.g., an offset press on a substrate (e.g. a metallized substrate), including an opaque white ink in the area over which the image area of the watch will later be printed. Then, in a second step, the image of the watch is printed over the opaque white area. The watch image may be printed using the same printing device as used to print the rest of the box, or a different printing device. Providing a white primer on the box prior to printing the watch in color may have certain benefits for producing a desirable final printed product, as is well known in the art.

Similar to the first two examples, it may not be possible to describe the color characteristics of the entire surface of this printed box with a single color profile or device link due to different portions of the images having different characteristics underneath the printed image (e.g. bare substrate vs. white underprint). In one example, a first profile or device link may be needed for the areas printed on the bare substrate, while a second profile or device link may be needed for the areas printed over the opaque white area. Therefore, the profile proof conversion method shown in FIG. 2A and the device link conversion method shown in FIG. 2B may employ two profiles or two device links when creating the proof for the printed product. This ensures that proof 206/306 is accurately displayed to the user on the proofing device based on the unique characteristics of the different printing devices.

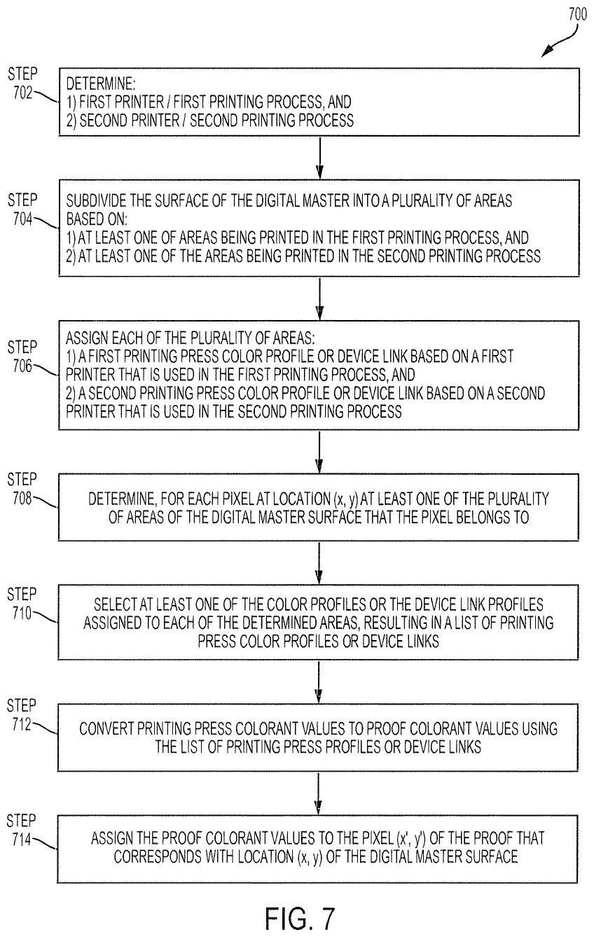

FIGS. 2-6 show examples of generating proofs for printed products produced by a multi-stage printing process. Shown in FIG. 7 is a flowchart describing details of the proof generating process.

In step 702 the a host computer (e.g. host computer 302 of the proofing device 304) determines the number of printing processes for producing the box, and the printing device information (e.g. the gamuts of the printing devices used in the process). This step can be accomplished by the user and/or a computer program selecting/identifying the printing devices to be used in the multi-stage printing process of the product identifier.

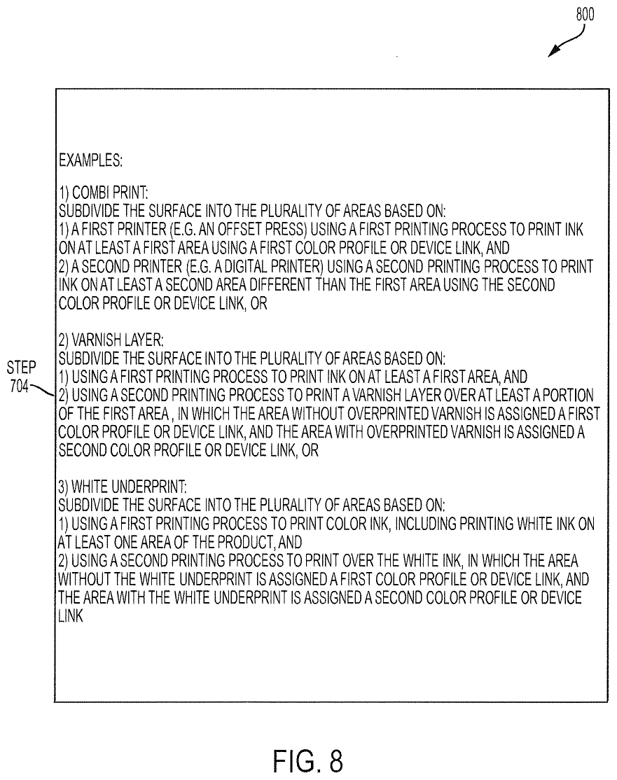

In step 704, the host computer subdivides the surface of the digital master image into multiple areas which may or may not overlap. This subdivision is based on the assumption that some of the areas are to be printed in a first printing process, which may include a first printing device and/or a first combination of colorants or color-affecting characteristics, while other areas are to be printed in a second printing process which may include a second printing device and/or a second combination of colorants or color-affecting characteristics. Please note that step 704 is described in more detail in FIG. 8 with respect to the Combi Printing, Varnish Printing and White Underprint process. As referred herein, the term “color-affecting characteristics” may include the type of printing device, the colorants, or the effect of varnish printed over a printed image or of white printed under a printed image. The term “colorants” may refer to ink, dye or any applied vehicle that provides any perceptible color, including the color white. While some varnishes may have measurable color (and therefore may be considered colorants), to the extent other varnishes may have no perceptible color of their own but are known to boost the color of the graphics underneath, they at least have a color-affecting characteristic which is well-characterized and can be included in a profile.

In step 706 the host computer assigns each of the subdivided areas to a specific printing process having specific color-affecting characteristics. Each subdivided area is then assigned a color profile or a device link. This entails that some of the areas of the digital master are assigned to a first profile or device link (e.g. based on the first printing device having first colorants having a first underprint characteristic and a first overprint characteristic), while other areas are assigned to a second profile or device link (e.g. based on a second printing device having second colorants having a second underprint characteristic and a second overprint characteristic, such as a varnish overprint). It should be understood that only one of listed characteristics need be different between the first profile and the second profile, but more than one characteristic may be different. It should also be understood that the underprint characteristic, although described herein in connection with a white opaque underprint, may also relate to a substrate that has variable characteristics. For example, a first area of the substrate may comprise a cardboard or paper surface and a second area may comprise a plastic and/or metallized surface (such as a physical layer applied over the paper or cardboard surface), which substrate variability may not be a printed characteristic, but rather a physical difference in materials of construction. Also, it should be understood that the underprint and overprint characteristic may be a null characteristic (e.g. no underprinting or no overprinting).

In step 708 the host computer determines, for each pixel location (x, y), at least one of the areas of the digital master surface where that pixel belongs. This is accomplished for example, by CMM 204/304 described in FIGS. 2A and 2B. It should be noted that each pixel location (x, y) of the digital master may belong to one or more than one area.

In step 710, the host computer then selects the color profiles or device links assigned to each of the determined areas, resulting in a list of color profiles or device links. This list may include one or more color profiles or device links each pixel location (x, y). For example, if a pixel location (x, y) of the digital master belongs to one distinct area, then the host computer selects the color profile or device link for that distinct area. If, however, the pixel location (x, y) of the digital master belongs to two or more overlapping areas, then the host computer selects the color profiles or device links for the two or more overlapping areas (e.g. a pixel location (x, y) will have a color profile or device link for each area that it belongs to). This list of color profiles and device links is then used in step 712 to convert the printing device colorant values to proof colorant values as described with respect to FIGS. 2A and 2B.

In step 714 the host computer assigns proof colorant values to the pixel (x′, y′) of the proof that corresponds with location (x, y) of the digital master surface.

This produces the proof that is ultimately displayed to the user prior to the printing process. The user can then either approve or reject the proof for printing.

Although FIG. 7 described the proofing process with respect to FIGS. 2A and 2B, FIG. 8 describes further details of step 704. Specifically, details in FIG. 8 describe examples for dividing the surface of the digital master into various areas based on the “Combi Print”, the “Varnish Layer Print” and the “White Underprint” methods shown in FIGS. 4-6.

In a first example in which the multi-stage printing process is a Combi Print process, the host computer utilizes this information to generate the appropriate proof in step 704(1). Generally, the host computer subdivides the surface into the plurality of areas based on: 1) the first printing device being an offset press using the first printing process to print ink on at least a first one of the areas of the product identifier using the first printing press color profile or device link, and 2) the second printing device being an digital printing device using the second printing process to print ink on at least a second one of the areas of the product identifier different than the first one of the areas using the second printing press color profile or device link.

In an example in which the multi-stage printing process is a Varnish Layer Print process, the host computer utilizes this information to generate the appropriate proof in step 704(2). Generally, the host computer subdivides the surface into the plurality of areas based on: 1) the first printing device being an offset press using the first printing process to print color ink on at least a first one of the areas of the product identifier using the first printing press color profile or device link, and 2) the second printing device being the same or a different printing device (e.g. a digital printing device) using the second printing process to print an overprint (e.g. varnish) layer on the first one of the areas of the product identifier directly over the initially printed color ink using the second printing press color profile or device link.

It should be understood that the second profile is a profile that reflects the known combination of the initial printing plus the varnish, and is interpreted by the host computer using algorithms known for mimicking such a profile using the host computer. Thus, a blending algorithm may be used to, for example, characterize the effect of a white underprint and specific colorants, or a set of colorants on a specific substrate with a specific varnish overprint, as are well known in the art. Thus, while each area may be defined by overlapping printing areas (e.g. a first area printed using a known printing device using known colorants, and a second area printed over the first area using the same printing device using a known varnish; or a first area printed using a known white opaque underprint, and a second area printed over the first area using the same printing device using known colorants), it should be understood that in a preferred embodiment, each area is resolved to a single profile or device link. For example, the combination of the original print plus the varnish has known characteristics that may be expressed in a single profile, just as the combination of a white opaque ink printed over a specific substrate over which is printed another set of colorants may be expressed in a single profile or device link.

In an example in which the multi-stage printing process is a White Underprint process, the approver computer utilizes this information to generate the appropriate proof in step 704(3). Generally, the approver computer subdivides the surface into the plurality of areas based on: 1) the first printing device being an offset press using the first printing process to print color ink on at least a first one of the areas of the product identifier using the first printing press color profile or device link without an opaque white ink underprint, and 2) the second printing device being either the same or a different (e.g. a digital printing device) using the second printing process comprising printing a colorant on at least the second one of the areas of the product identifier over the opaque white ink using the second printing press color profile or device link.

Although in step 704, the host computer subdivides the surface of the digital master assuming printing via Combi Print, Varnish Layer Print or White Underprint, it is contemplated that other printing processes may be used, so long as at least one characteristic of at least one area of the final intended print has a different color-affecting characteristic than another area of the print. It should be noted that multiple non-contiguous areas of the final intended print may have the same characteristics different than the remaining printed area, and/or more than two different areas may be present in a single final printed area, including color-affecting characteristics of more than two printing steps overlapping with one another. The host computer may be programed to recognize other printing processes and subdivide the digital mater accordingly.

Although not shown, the host computer may be pre-programmed to generate proofs based on any number of multi-stage printing methods using any type of printing device. In one example, the user may be presented with a graphical user interface (GUI) allowing the user to create or simply select a multi-stage printing process specific to the product identifier. The user could create/select the image to be printed, the areas to be printed by specific printing devices, the types of ink to be used, the substrate characteristics, the underprint characteristics, the overprint characteristics, the number of printing stages, etc. In another example, a computer programmer may pre-program this information into the host computer corresponding to known profiles or combinations of profiles representative of expected final printing conditions. In either example, the host computer then performs the process of generating the accurate proof based on the ultimate printing processes selected. The algorithms needed to characterize various printing process and/or the experimental steps needed to develop such algorithms are well known in the art.

As described, the master document is subdivided into areas that may or may not overlap each other. This subdivision may be accomplished external to the master PDF, for example, by using the GUI of the proofer program. For example, the image could be defined in another file format (e.g. CAD file, bitmap file, or it could be drawn by the user) and then subdivided by the program.

In addition, this subdivision may be encoded in the master PDF itself using PDF objects. For example, objects in a PDF Optional Content Group (OCG) may be used, where the OCG has a specific name e.g. “Varnish” that is recognized by the proofer program. In a second example, objects in a PDF OCG where the OCG has specific metadata in an OCG dictionary may be used. In yet a third example, objects that are colored with a certain spot color e.g. objects that have a stroke with the spot color “Varnish” may be used.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in fewer than all features of a single disclosed embodiment. Thus the following claims are hereby incorporated into the Detailed Description, with each claim standing on its own as a separately claimed subject matter.

What is claimed is:

1. A method to produce a color accurate proof of a printed product, comprising:
(a) subdividing, by a host computer, a surface of a digital master of the printed product into a plurality of areas based on at least a first area of the printed product being printed having a first set of color-affecting printing characteristics and at least a second area of the printed product having a second set of color-affecting printing characteristics;
(b) assigning, by the host computer, each of the plurality of areas a printing press color profile or device link based on the respective set of color-affecting printing characteristics corresponding to the respective area; and
(c) converting, by the host computer, colors from colorspaces corresponding to each set of color-affective printing characteristics to a colorspace of a proofing device by:
(i) determining, for each pixel at location (x, y) at least one of the plurality of areas of the digital master surface that the pixel belongs to, where x and y are variables defining a two dimensional space of the digital master,
(ii) selecting the color profile or the device link profile assigned to each of the determined areas, resulting in a list of color profiles or device links,
(iii) converting final print color-affecting values to proofing device colorant values using the list of printing press profiles or device links, and
(iv) assigning the proofing device colorant values to the pixel (x′, y′) of the proof that corresponds with location (x, y) of the digital master surface.

2. The method in claim 1, including:
subdividing, by the host computer, the surface so that the areas are non-overlapping and each area includes one printing press profile or device link.

3. The method in claim 1, including:
converting, by the host computer, the printing press colorants to proofing device colorants by:
converting, by the host computer, the set of color-affecting printing characteristics to proofing device colorants for each printing press profile or device link in the list, and
combining, by the host computer, the proofing device colorants to mimic the final print color-affecting values using a blending algorithm.

4. The method in claim 1, including:
subdividing, by the host computer, the surface of the digital master in areas using data embedded in a portable document format (PDF) file.

5. The method in claim 4, including:
using, by the host computer, PDF file objects that are colored using spot colors with specified names to subdivide the surface of the digital master.

6. The method in claim 5, including:
using, by the host computer, the PDF file objects that are member of optional content groups with specific names to subdivide the surface of the digital master

7. The method in claim 5, including:
using, by the host computer, the PDF file objects that are member of optional content groups with specific metadata in the OCG dictionary to subdivide the surface of the digital master

8. The method in claim 1, including:
subdividing, by the host computer, the surface of the digital master in areas using data external to the PDF file.

9. The method in claim 1, including:
subdividing, by the host computer, the surface of the digital master of the printed product into the plurality of areas based on:
the first set of color-affecting printing characteristics corresponding to a first printing device using the first printing process to print ink on at least a first one of the areas of the product identifier using the first printing press color profile or device link, and
the second set of color-affecting printing characteristics corresponding to a second printing device configured to perform a second printing process to print ink on at least a second one of the areas of the product identifier different than the first one of the areas using the second printing press color profile or device link.

10. The method in claim 1, including:
subdividing, by the host computer, the surface of the digital master of the printed product into the plurality of areas based on:
the first set of color-affecting characteristics comprising a first printing process to print color ink on at least a first one of the areas of the product, and
the second set of color-affecting characteristics comprising printing a varnish layer on the first one of the areas of the product identifier over the color ink.

11. The method in claim 1, including:
subdividing, by the host computer, the surface of the digital master of the printed product into the plurality of areas based on:
the first set of color-affecting printing characteristics comprising a first printing process printing color ink on at least a first one of the areas of the product using the first printing press color profile or device link, including printing white ink on at least a second one of the areas of the product, and
the second set of color-affecting printing characteristics comprising a second printing process comprising printing color ink on at least the second one of the areas of the product identifier over the white ink as characterized by the second printing press color profile or device link.
